(19) United States
(12) Patent Application Publication
(10) Pub. No.: US 2023/0141336 A1
(43) Pub. Date: May 11, 2023

(54) FOOD LAMINA AND USE OF SAME

(71) Applicant: ANINA CULINARY ART LTD., Ashdod (IL)

(72) Inventors: Meydan LEVY, Mabu'im (IL); Ester BRANTZ, Jerusalem (IL); Idan SHAFRIR, Kfar Shmuel (IL); Anat NATAN, Ra'anana (IL); Dorit ROZNER, Gedera (IL)

(21) Appl. No.: 18/089,749

(22) Filed: Dec. 28, 2022

Related U.S. Application Data
(63) Continuation of application No. PCT/IL2022/050688, filed on Jun. 27, 2022.
(60) Provisional application No. 63/215,588, filed on Jun. 28, 2021.

(51) Int. Cl. A23L 19/00

(52) U.S. Cl. CPC A23L 19/05; A23L 19/07

(57) ABSTRACT

This disclosure relates to laminas and uses of same, the lamina made of at least 90% w/w dried, adhered together vegetables, the lamina withstanding disintegration during storage and allowing disintegration when cooked.

### CROSS REFERENCE TO RELATED APPLICATIONS

This application is a Bypass Continuation of PCT Patent Application No. PCT/IL2022/050688 having International filing date of Jun. 27, 2022 which claims the benefit of priority of U.S. Provisional Patent Application No. 63/215,588, filed Jun. 26, 2021, the contents of which are all incorporated herein by reference in their entirety.

### TECHNICAL FIELD OF INVENTION

This disclosure generally relates to food laminas, in particular food laminas made of vegetables or fruits, the lamina maintaining its integrity during storage while allowing controlled disintegration into an edible food product when prepared.

### BACKGROUND

The invention relates to vegetable laminas. Specifically, vegetable laminas for use in packaging/encapsulation of food stuff, as well as to methods of producing such laminas.

It is well known to pack food in wraps, bags, pouches etc. made of laminas. However, these laminas are typically synthetic and as such a part of the ecological problem of increasing amounts of polymeric waste.

Global food waste amounts to between one-third and one-half of all food produced. In low-income countries, most loss occurs during production, while in developed countries much food—about 100 kilograms (220 lb) per person per year—is wasted at the consumption stage. Food waste is a major part of the impact of agriculture on climate change and other environmental issues. The Food and Agricultural Organization estimated in 2014 that food waste lost causes a global economic, environmental and social cost of $2.6 trillion a year and is responsible for 8 percent of global greenhouse gas emissions. Moreover, food waste that is not handled or reclaimed properly, i.e. through composting, can have many negative environmental consequences. For example, landfill gas from anaerobic digestion of organic matter is a major source of the greenhouse gas methane, and un-reclaimed phosphorus in food waste, leads to further phosphate mining.

Instant food usually refers to precooked food that requires very little preparation prior to eating it. This often includes foods that are dehydrated and just require the addition of water to prepare. The marketing concept behind the idea of instant food is that people in fast-paced, mobile societies no longer have the time to cook and prepare food in the traditional manner, yet they still want meals that are nutritious and taste good. Convenience food labeled as instant food is an attempt to satisfy this need, while being palatable enough so that consumers will choose them over foods that require the use of recipes and cooking. However, ready-made food sometimes has the reputation of being loaded with preservatives, additives, and other potentially harmful fillers, food colors, and so on, which can give it a negative image in the mind of the consumer when shopping for groceries.

There is therefore a need to expand the range of natural, healthy prepared foods, including particularly instant meals, by providing new healthy food substrates that may serve for nutrition and for other purposes. It is very important to ensure that these new healthy coated food substrates are flavorful and attractive so that they obtain wide acceptance. The products need be natural and inherently healthy, and an overall appearance, resulting in strong consumer acceptance and demand.

### SUMMARY

There is provided herein, according to some aspects of the disclosure, a lamina comprising at least about 90% w/w dried vegetables sliced, cut and/or grinded into a desired form, wherein the lamina has a thickness of approximately 0.5-4 mm, a strength of 0.05-0.5 Mpa, a water content in a range of approximately 5%-35% and a water activity (aw) of approximately 0.2-.0.6.

According to some embodiments, the lamina further comprises a natural edible adhesive adhering the vegetables together.

According to some embodiment, the adhesive may advantageously be configured to withstand disintegration of the lamina during storage and to allow controlled disintegration of the lamina into edible vegetables when cooked or otherwise prepared, thereby being useful for encapsulation of food-products.

Advantageously, the vegetables used for the lamina may be food waste vegetables, i.e. vegetables which are discarded or intended to be discarded, while still being edible. According to some embodiments, such laminas may be particular advantageous for packaging purposes.

According to other aspects, there is provided a ready to cook meal including an outer encapsulating lamina having a thickness of about 0.5-4 mm, a strength of 0.05-0.5 Mpa, the lamina comprising at least about 90% w/w sliced and dried vegetables adhered together such that two neighboring slices at least partially overlap and, a core including a dry, essentially non-cooked food product. The ready to cook-meal has a water content in a range of approximately 5%-35% and a water activity (aw) of about 0.2-.0.5.

According to some embodiments, the lamina further comprises a natural edible adhesive adhering the vegetables together. According to some embodiments, the adhesive is configured to withstand disintegration during storage and even when immersed in room temperature water while allowing controlled disintegration of the lamina into edible vegetable slices when cooked or otherwise prepared.

Advantageously, the controlled disintegration may facilitate time-adjusted cooking of the dry, essentially non-cooked, encapsulated food-product.

According to some embodiments, there is provided a lamina comprising at least about 90% w/w dried vegetables, the vegetables sliced, cut or grinded into a desired form. According to some embodiments, the lamina has a thickness of about 0.5-4 mm. According to some embodiments, the lamina has a strength of 0.05-0.5 Mpa. According to some embodiments, the lamina has a water content in a range of approximately 5%-35%. According to some embodiments, the lamina has a water activity (aw) of about 0.2-.0.6. According to some embodiments, the lamina is configured to withstand disintegration during storage and to allow controlled disintegration into edible vegetables when cooked.

According to some embodiments, the dried vegetables comprise sliced vegetable in which case the adhesive adheres the vegetable slices together, such that two neighboring slices at least partially overlap. According to some embodiments, the adhesive covers at least a portion of overlapping surfaces of the vegetable slices.

According to some embodiments, the lamina further comprises a natural edible adhesive adhering the vegetables together.

According to some embodiments, the adhesive is configured to withstand disintegration of the lamina when immersed in water having a temperature of about 40° C. or below for at least about 20 minutes.

According to some embodiments, the adhesive is configured to withstand disintegration of the lamina when immersed in water having a temperature above about 80° C. for at least about 3 minutes.

According to some embodiments, the adhesive comprises a plant resin. According to some embodiments, the adhesive comprises a natural mucilage and/or gum plant gum.

According to some embodiments, the adhesive further comprises a natural starch, fiber, sugar, protein or any combination thereof.

According to some embodiments, the lamina has a thickness of approximately 0.5-2 mm.

According to some embodiments, the lamina has a water content in a range of approximately 10%-35% in a first moldable configuration and a water content of approximately 5%-20% or 5%-15% or 2%-12% in a second non-moldable final configuration. Each possibility is a separate embodiment.

According to some embodiments, the lamina has a water activity (aw) of approximately 0.3-.0.5 in its final non-moldable configuration.

According to some embodiments, the lamina comprises at least 95% w/w dried vegetables.

According to some embodiments, the adhesive is configured to withstand disintegration for at least 1 week at room temperature.

According to some embodiments, the lamina is devoid of artificial ingredients and synthetic chemicals.

According to some embodiments, the lamina is devoid of oil or added fat.

According to some embodiments, the lamina has a strength of 0.05-0.5 Mpa.

According to some embodiments, the lamina has a water content in a range of 5%-25%. According to some embodiments, at least one surface of the lamina is coated with a coating.

According to some embodiments, the lamina is configured for encapsulation of one or more dry, essentially non-cooked food products ingredients. According to some embodiments, the amount and type of the adhesive is determined based on the amount of time required for cooking the dry, essentially non-cooked food product.

According to some embodiment, there is provided a ready to cook meal comprising an outer encapsulating lamina and a core comprising a dry, essentially non-cooked food product.

According to some embodiments, the lamina has a thickness of approximately 0.5-4 mm. According to some embodiments, the lamina comprises at least 90% w/w vegetables and a natural edible adhesive adhering the vegetable together.

According to some embodiments, the vegetables are dried. According to some embodiments, the vegetables are semi dried to maintain a water content of 5%-35%. Alternatively, the vegetables are fully dried (water content below 5%, below 2% or below 1%, whereafter the vegetables are rehydrated to a water content of 5%-35%.

According to some embodiments, the vegetables are sliced. According to some embodiments, the adhesive is configured to adhere neighboring vegetables together, such that two neighboring slices at least partially overlap.

According to some embodiments, the lamina of the ready to cook-meal capsule has a water content in a range of approximately 5%-15%, of approximately 5%-12% or of approximately 5%-10%. Each possibility is a separate embodiment. According to some embodiments, the ready to cook-meal has a water activity (aw) of approximately 0.2-0.5. According to some embodiments, the capsule is configured to withstand disintegration during storage and when immersed in room temperature water, and to allow controlled disintegration thereof into edible vegetable slices when cooked, thereby facilitating time-adjusted cooking of the dry, essentially non-cooked food product.

According to some embodiments, the lamina has a water content in a range of approximately 10%-35% in a first moldable configuration and a water content of approximately 5%-20% in a second non-moldable final configuration.

According to some embodiments, the amount and type of the adhesive is determined based on the amount of time required for cooking the dry, essentially non-cooked food product.

According to some embodiments, the outer encapsulating lamina comprises a first lamina and a second lamina, wherein a rim of the first lamina and a rim of the second lamina are adhered to one another, thereby generating a closed capsule encapsulating the dry pre-cooked dish.

According to some embodiments, the first lamina and the second lamina are same or different.

According to some embodiments, the adhesive comprises a plant resin. According to some embodiments, the adhesive comprises a natural mucilage and/or gum plant gum.

According to some embodiments, the adhesive further comprises a natural starch.

According to some embodiments, the ready-to-cook meal has a water activity (aw) of approximately 0.3-0.4.

According to some embodiments, the outer encapsulating lamina comprises at least about 95% w/w dried vegetables.

According to some embodiments, the ready-to-cook meal has a shelf life of at least about 3 months at room temperature.

According to some embodiments, the ready-to-cook meal is devoid of artificial ingredients and synthetic chemicals.

According to some embodiments, there is provided a process for manufacturing a vegetable lamina comprising: adhering pre-dried vegetables to each other such that two neighboring slices at least partially overlap, thereby obtaining a lamina having a of approximately 0.5-3 mm, a water content in a range of approximately 5%-35% and a water activity (aw) of approximately 0.2-.0.8, wherein the lamina is configured to withstand disintegration during storage and to allow controlled disintegration into edible vegetable slices when cooked.

According to some embodiments, the vegetables are vegetables sliced, cut or grinded into a desired shape or form.

According to some embodiments, the vegetables are adhered using a natural edible adhesive. According to some embodiments, the natural adhesive may be a natural constituent of the vegetable. Additionally, or alternatively, the natural adhesive may be added to (e.g. applied on) the vegetables. According to some embodiments, the vegetables are sliced and the adhering comprises applying the adhesive at least on a portion of the vegetable slices.

According to some embodiments, there is provided a process for producing a ready-to-cook meal, the process comprising manufacturing a vegetable lamina, the manufacturing comprising adhering pre-dried vegetables to each other, manufacturing a capsule comprising an outer laminal layer and an inner essentially non-cooked dry food product, thereby obtaining a ready-to-cook meal capsule capable of withstanding disintegration during storage and to allow controlled disintegration into edible vegetable slices when cooked.

According to some embodiments, manufacturing the lamina results in lamina having a thickness of approximately 0.5-3 mm. According to some embodiments, manufacturing the lamina results in lamina having a water content in a range of approximately 5%-20%. According to some embodiments, manufacturing the lamina results in lamina having a water activity (aw) of approximately 0.2-.0.8. According to some embodiments, manufacturing the lamina results in lamina having a strength of 0.05-0.5 Mpa.

According to some embodiments, further comprising a prior step of slicing, chopping, cutting or grinding the vegetables into a desired form/pieces. Each possibility is a separate embodiment.

According to some embodiments, the vegetables may be pre-cooked (e.g. steamed, bleached or the like).

According to some embodiments, adhering the vegetables pieces comprises applying the adhesive on at least portion of thereof and arranging the vegetable pieces such that the parts of two neighboring pieces on which the adhesive has been applied at least partially overlap.

According to some embodiments, the manufacturing of the capsule comprises molding the at least one lamina into a desired form, placing the food product between two layers of the molded lamina, and closing the lamina into a capsule enclosing the food product.

According to some embodiments, the adhering comprises applying the adhesive at least on a portion of the vegetable slices.

According to some embodiments, manufacturing the capsule comprises obtaining a first lamina and a second lamina, the molding comprises molding at least the first lamina into a bowl-like shaped lamina. According to some embodiments the placing of the essentially non-cooked food product between two layers comprises filling the first bowl-like shaped lamina with the dry essentially non-cooked food product. According to some embodiments, the closing comprises covering the first bowl-shaped lamina with the second flat or bowl-shaped lamina and attaching rims of the first and second bowl-shaped laminas to one another.

According to some embodiments, the attaching comprises mechanical pressing.

According to some embodiment, there is provided a lamina comprising at least 80% w/w, at least 90% w/w, at least 95% w/w or at least 99% w/w dried fruits, the fruits sliced, cut or grinded into a desired shape, wherein the lamina has a thickness of 0.5-4 mm, wherein the lamina is configured to withstand disintegration during storage and to allow controlled disintegration of the lamina into edible fruits upon hydration.

According to some embodiments, the lamina is devoid of oil or added fat.

According to some embodiments, the lamina comprises a natural edible adhesive adhering the fruits together,

According to some embodiments, there is provided a breakfast capsule comprising: an outer encapsulating fruit lamina having a thickness of 0.5-4 mm and a strength of 0.05-0.5 Mpa, the lamina comprising at least 90% w/w dried and sliced, cut, grinded or mashed fruits; a core comprising nuts, seeds, cereals, dried fruits or any combination thereof; wherein the lamina of the breakfast capsule has a water content in a range of 5%-15% and a water activity (aw) of 0.2-0.5, and wherein the lamina is configured to withstand disintegration during storage and to allow disintegration thereof when hydrated.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF THE FIGURES

The patent or application file contains at least one drawing executed in color. Copies of this patent or patent application publication with color drawing(s) will be provided by the Office upon request and payment of the necessary fee. The invention will now be described in relation to certain examples and embodiments with reference to the following illustrative figures so that it may be more fully understood.

FIG. 1A is an illustrative image of zucchini sliced into pieces suitable for lamina formation, according to some embodiment.

FIG. 1B is an illustrative image of pumpkin sliced into pieces suitable for lamina formation, according to some embodiment.

FIG. 2 is an illustrative diagram of lamina preparation, according to some embodiments.

FIG. 3A is an illustrative image of a final lamina, according to some embodiments.

FIG. 3B is an illustrative image of laminas formed from different vegetables using various types of cutting a) chopped cabbage, b) crushed tomatoes, c) sliced squash, d) sliced pumpkin, e) sliced eggplant f) sliced zucchini and pumpkin, according to some embodiments.

FIG. 4A is an illustrative image of a lamina molded into a bowl shape, according to some embodiments.

FIG. 4B is an illustrative image of the lamina of FIG. 4A in which the bowl is loaded with a food product (here a lentil dish), according to some embodiments.

FIG. 4C is an illustrative image of a lamina molded into a bowl shape and with the herein disclosed adhesive on its rim (indicated by arrow), according to some embodiments.

FIG. 4D is an illustrative image of the final ready-to-cook-product in which the loaded bowl of FIG. 4B is closed by the bowl-shaped lamina of FIG. 4C, thereby forming a capsule like ready-to-cook meal.

FIG. 4E is an illustrative diagram of the process of encapsulation with 2 molded laminas.

FIG. 4F is an illustrative diagram of the process of encapsulation with only one molded lamina.

FIG. 5A is an illustrative image of another ready-to-cook-capsule formed using a lamina including an assortment of chopped and cut vegetables.

FIG. 5B is an illustrative image of additional ready-to-cook-capsules having various shapes and formed using different laminas a) sliced zucchini and pumpkin, b) sliced eggplant and radish, c) sliced tomato and dates, d) sliced beetroot and chopped parsley e) chopped cabbage and sliced carrot.

FIG. 6 is a representative histogram of lamina breaking time depending on source of adhesive.

FIG. 7 is a representative graph showing the breaking time of a lamina as disclosed herein, depending on the amount of fiber added to the adhesive.

FIG. 8A is an illustrative image showing a representative 3D capsule shaped lamina before (complete whole lamina; left) and after (cracked lamina having a hole; right) being tested for its ability to withstand the pressure applied and measured by a probe using a Lioyd device model TA1. The prob having a diameter of 11.15 mm and a contact area of 97.64 was moved towards the lamina in a speed of 60 mm/min. A preload stress of 3N and a height limit of 15 mm were set.

FIG. 8B is an illustrative image showing several different cracked 3D capsule shaped laminae having a hole, after being tested for their maximal strength/maximal ability to withstand pressure applied by the probe of A. Pictures of Tommato, Eggplant, Beet, Pumpkin, and Radish based 3D capsule shaped laminae are presented.

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

For convenience, certain terms used in the specification, examples, and appended claims are collected here. Unless otherwise defined, all technical and scientific terms used herein have the same meaning as commonly understood by one of ordinary skill in the art to which this invention pertains.

There is provided herein, according to some aspects of the disclosure, a lamina made of at least about 80% w/w, preferably at least about 90% w/w, at least about 95% w/w or at least about 98% w/w dried fruits or vegetables. Each possibility is a separate embodiment.

As used herein, the term “lamina” refers to a two-dimensional planar closed surface with mass and density. According to some embodiments, the term lamina may be substituted with the term “sheet”.

As used herein, the term “vegetable” usually refers to herbaceous plant (such as the cabbage, bean, or potato) grown for an edible part. Collectively the term refers to all edible plant matter, including some flowers (e.g. broccoli), savory fruits (e.g. tomatoes and courgettes), stems, leaves and roots.

As used herein, the term “fruit” refers to the seed-bearing structure of flowering plant that is formed from the ovary after flowering. According to some embodiments, the term refers more narrowly to the ripened ovaries that are sweet and either succulent or pulpy.

According to some embodiments, the fruits/vegetables may be sliced, cut, grinded and/or minced into a desired form. According to some embodiments, the lamina may be formed by overlapping pieces (e.g. slices) of dried vegetables, in which case the adhesive adheres the vegetable pieces together. According to some embodiments, the adhesive may cover at least the portions of the vegetable pieces.

According to some embodiments, the lamina may be made from a single type of fruit/vegetable e.g. sweet potato. According to some embodiments, the lamina may be made of different fruits/vegetables, e.g. eggplant and pumpkin. According to some embodiments, the lamina may include at least about 2, at least about 3 or at least about 4 different types of vegetables. Each possibility is a separate embodiment.

According to some embodiments, the fruits/vegetables may be sliced/cut or otherwise turned into pieces preferably in such way the type of the fruit/vegetable remains recognizable.

According to some embodiments, the fruits/vegetables may be fruits/vegetables as food waste or food loss fruits/vegetables. As used herein, the term food waste and food loss may refer to any fruits/vegetables which have been discarded (e.g. for “cosmetic” reasons) or intended to be discarded, while still being edible, preferably human grade.

According to some embodiments, at least some of the fruits/vegetables in the lamina may have a distinct form (e.g. a vegetable slice). Additionally or alternatively, at least some of the vegetables in the lamina may be minced into a puree (e.g. a fruit puree).

According to some embodiments, the lamina may have a thickness of approximately 0.2-6 mm, or approximately 0.3-5 mm, approximately 0.4-5.5 mm, approximately 0.5-4 mm, approximately 0.6-3 mm, approximately 0.5 mm-2 mm or any other range within the range of 0.2-6 mm. Each possibility is a separate embodiment.

According to some embodiments, the lamina may have a water content in a range of about 2%-40%, about 5%-35%, about 10%-35%, about 5%-30%, about 10%-30%, about 15%-30% or any other percentage within the range of about 2%-40%. Each possibility is a separate embodiment.

According to some embodiments, the lamina may have a water content in a range of about 2%-40%, about 5%-35%, about 10%-35%, about 5%-30%, about 10%-30%, about 15%-30% or any other percentage within the range of 2%-40% in a first moldable configuration and a water content of about 2-18%, about 5%-15%, about 5-10% or any other percentage in the range of 2-18% in a second non-moldable final configuration. Each possibility is a separate embodiment.

As used herein, the term “moldable configuration” refers to a configuration in which it is possible to bend, twist or otherwise manipulate the lamina to form a desirable shape.

As used herein, the term “non-moldable configuration” refers to a final configuration of the lamina in which it is no longer possible to shape the lamina. In this configuration the lamina is suitable for storage for at least 1 month, at least two months or at least three months at room temperature. Each possibility is a separate embodiment.

According to some embodiments, the “non-moldable configuration” may be reversed by rehydration of thereof. This may be particular advantageous for storing purposes during production.

According to some embodiments, the lamina may have a water activity (a_{w}) of approximately 0.2-.0.6 or approximately 0.3-0.5 or approximately 0.4-0.6. Each possibility is a separate embodiment. As used herein, the term “water activity (a_{w})” may refer to the partial vapor pressure of water in a solution divided by the standard state partial vapor pressure of water. In the field of food science, the standard state is most often defined as the partial vapor pressure of pure water at the same temperature. Using this particular definition, pure distilled water has a water activity of exactly one.

According to some embodiments, the vegetables are adhered using a natural edible adhesive. According to some embodiments, the natural adhesive may be a natural constituent of the vegetable. Additionally, or alternatively, the natural adhesive may be added to (e.g. applied on) the vegetables.

According to some embodiments, the adhesive is configured to withstand disintegration of the lamina during storage and to allow controlled disintegration of the lamina into edible vegetables when cooked or otherwise prepared.

As used herein, the term “disintegration” may refer to a separation of the fruit/vegetable into slices and/or pieces and/or to the formation of a soft minced form of the fruit/vegetables. According to some embodiments, the adhesive is configured to withstand disintegration of the lamina when immersed in water having a temperature of approximately 40° C. or below, approximately 50° C. or below or approximately 60° C. or below, for at least about 20 minutes. Each possibility is a separate embodiment. According to some embodiments, the adhesive is configured to withstand disintegration for at least about 1 week, at least about 2 weeks, at least about 1 month, at least about 2 months or at least about 6 months, at room temperature. Each possibility is a separate embodiment.

As used herein, the term “cooked” may refer to the craft of using heat to prepare food for consumption. Cooking techniques may vary widely and include baking, roasting, frying, grilling, barbecuing, smoking, boiling, steaming and braising. According to some embodiments the cooking may involve immersing for subjecting the lamina to boiling water for a predetermined period of time. According to some embodiments, the cooking may include or be microwaving the lamina for a predetermined amount of time (e.g. at least about 2 min, at least about 5 min., at least about 7 min., but preferably no more than about 10 min or no more than about 20 min) in the presence of water. Each possibility is a separate embodiment.

According to some embodiments, the ready to cook meal is supplied with cooking instructions. As a non-limiting example, the ready to cook meal may be packed into a box and the cooking instructions may be printed onto the box.

According to some embodiments, the cooking techniques/instructions include boiling/heating the ready-to-cook capsule in a microwave. According to some embodiments, the capsule is to be placed in a bowl, immersed in about 240 ml of water, and covered before being cooked in the microwave for about 8 min or 9 min.

According to some embodiments, the cooking techniques/instructions include boiling the ready-to-cook capsule in a pot. According to some embodiments, the capsule is to be placed in a pot and immersed in about 240 ml of water which is allowed to boil before the flame is lowered and the ready-to-cook capsule continues to cook for 5 min on a small flame.

According to some embodiments, the adhesive may be configured to withstand disintegration of the lamina when immersed in water having a temperature above about 80° C. for at least about 3 minutes or for at least about 5 minutes, but typically no more than about 10 minutes.

According to some embodiments, the adhesive includes or is a plant resin. As used herein the term “plant resin” may refer to solid or highly viscous substances obtained/extracted from plants. Non-limiting examples of plant resins include amber, balm of Gilead, balsam, Canada balsam, Boswellia, copal from trees of Protium copal and Hymenaea courbaril, dammar gum from trees of the family Dipterocarpaceae, dragon's blood from the dragon trees (Dracaena species), elemi, frankincense from Boswellia sacra, galbanum from Ferula gummosa, gum guaiacum from the Lignum vitae trees of the genus Guaiacum, kauri gum from trees of Agathis australis, hashish (Cannabis resin) from Cannabis indica, labdanum from mediterranean species of cistus, mastic (plant resin) from the mastic tree Pistacia lentiscus, myrrh from shrubs of Commiphora, sandarac resin from Tetraclinis articulata, the national tree of Malta, styrax (a Benzoin resin from various Styrax species), spinifex resin from Australian grasses or any combination thereof.

According to some embodiments, the plant resin may be a natural mucilage and/or a plant gum. As a non-limiting example, the mucilage may be a mucilage derived from okra, chia, sabras, flaxseed, fenugreek, zucchini, Aloe vera, cactus, kelp, liquorice root, marshmallow, psyllium seed husks or any combination thereof. Each possibility is a separate embodiment.

According to some embodiments, the plant resin may be a natural mucilage and/or a plant gum. As a non-limiting example, the mucilage may be a mucilage derived from okra, chia, sabras, flaxseed, fenugreek, zucchini, or any combination thereof. Each possibility is a separate embodiment.

According to some embodiments, the mucilage may be an isolated mucilage. According to some embodiments, the mucilage may be an ingredient in an extract/paste of the plant.

According to some embodiments, the resin may be a naturally occurring resin obtained from an origin other than plants such as but not limited to an insect-derived resin.

According to some embodiments, the adhesive further includes an additional ingredient such as a natural starch, a fiber, a sugar, a protein or any combination thereof. Each possibility is a separate embodiment. According to some embodiments, the additional ingredient may be configured to adjust the time-to-disintegration of the lamina. According to some embodiments, the additional ingredient may be configured to serve as a stabilizer and/or natural preservative.

As a non-limiting example, the adhesive may further include a Fructooligosaccharide (FOS) fiber. As used herein, the term “FOS fiber” may refer to a small dietary fiber made of short chain fructose molecules. FOS fibers typically have a low caloric value. According to some embodiments, the FOS fiber may be extracted from blue agave plant as well as from fruits and vegetables such as bananas, onions, chicory root, garlic, asparagus, jicama, and leeks, Grains and cereals, such as wheat and barley, Jerusalem artichoke, yacón or any combination thereof. Each possibility is a separate embodiment.

According to some embodiments, the adhesive may include approximately 1%-60% w/w, approximately 5%-50% w/w, approximately 10%-50%, approximately 10%-40% or any other range within 1%-60% of the additional ingredient (e.g. FOS).

Additionally or alternatively, the adhesive may further include a starch, such as but not limited to a rice starch, potato starch, arrowroot starch, tapioca starch, cornstarch or any combination thereof. Each possibility is a separate embodiment.

Additionally or alternatively, the adhesive may further include a exudate gum. Gums are complex carbohydrate molecules which have the ability to bind water and form gels at low concentration. The carbohydrates are often associated with proteins and minerals in their structure. Exudate gums are plant gums which secreted by barks typically as a protection mechanism upon injury. Exudate gums are characterized by high viscosity, adhesive property, stabilization effect, emulsification action and surface-active property. Non-limiting examples of exudate gums include acacia gum (also referred to as gum Arabic), karaya gum, ghatti gum, tragacanth gum and combinations thereof. Each possibility is a separate embodiment.

According to some embodiments, the adhesive may have a viscosity of at least about 10 cP, at a shear force of about 0.1 s⁻¹. According to some embodiments, the adhesive may have a viscosity in a range of approximately 5-100 cP, at a shear force of about 0.1 s⁻¹. According to some embodiments, the adhesive may have a viscosity of at least about 0.5-5 cP, at a shear force of about 100 s⁻¹.

According to some embodiments, the lamina is essentially devoid of artificial ingredients and synthetic chemicals such as but not limited to polymers (e.g. ethyl cellulose, PVA, methyl cellulose). According to some embodiments, the lamina is a clean-label product. As used herein, the term “clean label” may refer to a product using ingredients, preferably as few as possible, that consumers recognize and think of as wholesome ingredients that consumers might use at home. It typically refers to foods with easy-to-recognize ingredients and no artificial ingredients or synthetic chemicals, and it has become associated with “trust” with manufacturers of food.

According to some embodiments, the lamina is devoid of added sweeteners. As used herein the term “added sweeteners” may refer to sugars or synthetic substitutes added in order to sweeten the taste of the lamina.

According to some embodiment the lamina is configured for encapsulation of one or more dry, essentially non-cooked food products ingredients. According to some embodiments, the amount and type of the adhesive may be determined based on the amount of time required for cooking the dry, essentially non-cooked food product.

According to some embodiments, the lamina may be used for packaging of food or other ingredients. According to some embodiments, the lamina may be used for as an edible packaging. As used herein the term “edible packaging” may refer to a packaging intended for packaging of an item, e.g. a food product, while it itself being edible. According to some embodiments, the lamina may be non-edible.

According to some embodiments, at least one of the surfaces of the lamina may be coated with a coating material. According to some embodiments, the coating may be a natural coating, e.g. a gelatin, shellack, ethyl cellulose, methyl cellulose, PVA, natural wax or any combination thereof. Each possibility is a separate embodiment. According to some embodiments, the coating may be a coating configured to prevent water absorption. According to some embodiments, the coating may be configured to increase the tensile strength/flexibility of the lamina.

According to some embodiments, there is provided a ready to cook meal including an outer encapsulating lamina (as essentially described herein), the lamina made of at least 90% w/w dried vegetables and a natural edible adhesive configured to adhere the vegetables together, and a core comprising a dry, essentially non-cooked food product.

As used herein, the term “ready-to-cook meal”, “ready meal” may refer to a food product, which solely needs to be cooked in water in order to be suitable for human consumption.

As used herein, the term “essentially non-cooked food product” may refer to a food product (e.g. couscous) in its uncooked form or to a food product which has been pre-cooked and subsequently dehydrated, but which still need additional cooking in order to be ready for consumption.

As used herein, the term “dry” with regards to the food product refers to a food product including less than about 12%, less than about 10%, less than about 8%, less than about 5% or less than about 2% water. Each possibility is a separate embodiment.

According to some embodiments, the food product may include rice, quinoa, couscous, pasta, lentils, buckwheat, bulghur or any other suitable grain or seed or combination thereof, preferably seasoned to taste. According to some embodiments, the food product may be a dish including any of the above-mentioned food products mixed into a ready to be served meal when cooked.

According to some embodiments, the food product may include salt and/or spices. According to some embodiments, the food product may be devoid of added sugar.

According to some embodiments, prior to preparation (cooking), the ready to cook-meal has a water content approximately in a range of 5%-20%, or 10%-15%.

According to some embodiments, prior to preparation (cooking), the ready to cook-meal has a water activity (a_{w}) of approximately 0.2-0.5 or approximately 0.2-0.4.

According to some embodiments, the adhesive is configured to withstand disintegration of the encapsulating lamina during storage of the ready to cook meal. Surprisingly, the encapsulating lamina does also withstand disintegration when immersed in room temperature water.

Advantageously, the lamina allows for controlled disintegration of the lamina into edible vegetable slices when cooked, thereby facilitating time-adjusted cooking of the dry, essentially non-cooked food product. According to some embodiments, the amount and/or type of the adhesive may be determined based on the amount of time required for cooking for the specific dry, essentially non-cooked food product. As a non-limiting example, a lesser amount of adhesive and/or a weaker adhesive, e.g. a chia-derived mucilage, may be utilized when a longer cooking of the food product is needed, such as in the case of bulghur. As another non-limiting example, a higher amount of adhesive and/or a stronger adhesive e.g. zucchini or a flaxseed derived mucilage, may be utilized when a shorter cooking time of the food product is required (e.g. in case the food product is an instant (pre-cooked) food product such as instant rice or instant couscous). According to some embodiment, the amount and/or type of the adhesive may be such that all ready-to-cook meals have a same required cooking time (e.g. 5-10 min) regardless of the type of the food product encapsulated.

According to some embodiments, the outer encapsulating lamina may include a first lamina (sheet) and a second lamina (sheet), wherein a rim of the first lamina and a rim of the second lamina are adhered to one another, thereby generating a closed capsule encapsulating the dry essentially non-cooked food product, as further elaborated herein.

As used herein, the term “rim” refers to the outer sometimes curved or circular edge or border of the lamina.

According to some embodiments, the first lamina and the second lamina may be same or different. Non-limiting example of different laminas include laminas made from different fruits/vegetables. Other non-limiting example of different laminas include laminas made from the same kind of fruit/vegetable, but which have been cut differently and/or which have been arranged differently.

According to some embodiments, the ready to cook meal has a shelf-life of at least 2 months, at least 3 months, at least 4 months, or at least 6 months at room temperature.

According to some embodiments, the entire ready-to cook meal may be devoid of any synthetic/artificial ingredients, i.e. ingredients created from chemical sources rather than natural sources. According to some embodiments, the ready-to-cook meal is a clean-label product.

According to some embodiments, the ready-to-cook meal may be devoid of added sweeteners. As used herein the term “added sweeteners” may refer to sugars or synthetic substitutes added in order to sweeten the taste of the ready-to-cook meal.

According to some embodiments, there is provided a process for manufacturing a fruit/vegetable lamina, the manufacturing including a) drying the fruits/vegetables or obtaining already dried fruits/vegetables, b) building a lamina by adhering the dried vegetables to each other, using an edible adhesive, as essentially descried herein, and optionally c) molding the lamina into a desired shape.

Step a) is now explained in more detail. It is however clear that at least some of the steps described may be omitted, adjusted and/or their order changed. As a non-limiting example, according to some embodiments, the drying of the vegetables (step a) may be performed prior to the building of the lamina (step b). Alternatively, the building of the lamina (step b) may be performed prior to the drying of the vegetables (step a).

According to some embodiment, prior to drying the fruit/vegetables may be preprocessed. According to some embodiments, the pre-processing may include one or more of the following steps: i) washing the fruits/vegetables, and ii) disinfecting the fruits/vegetables. Optionally at this stage, the fruits/vegetables may be stored at about 4° C. before further processing.

According to some embodiments, at least a portion of the vegetables may undergo pre-cook treatment.

A non-limiting example of a pre-cook treatment/protocol may include one or more of the following steps:
1. Bleaching in water:
   i. adding slices of vegetables to boiled water for example for about 5 to 10 min.
   ii. Cooling to room temperature in low concentration of lemon juice in iced water.
2. Bleaching in steam:
   i. Arrangement of slices of vegetables on a tray with whole (net) introduce steam for example for about 5 to 10 min.
3. Cooking
   i. Cooking at boiling water for 3 to 10 min.
4. Washing
   i. Washing in fresh cold water (e.g. for about 10 to 30 min). Optionally fresh water may be introduced to the vegetables in 5 min cycles.
Non-limiting examples of vegetables suitable for bleaching in water may include roots like beet, sweet potato, and potato. Each possibility is a separate embodiment.
Non-limiting examples of vegetables suitable for bleaching in steam may include roots like beet, sweet potato, potato, and leaf vegetables as cabbage. Each possibility is a separate embodiment.
Non-limiting examples of vegetables suitable for cooking may include roots like beet, potato and sweet potato. Each possibility is a separate embodiment.
Non-limiting examples of vegetables suitable for washing may include vegetables with high content of starches like potato and sweet potato. Each possibility is a separate embodiment.

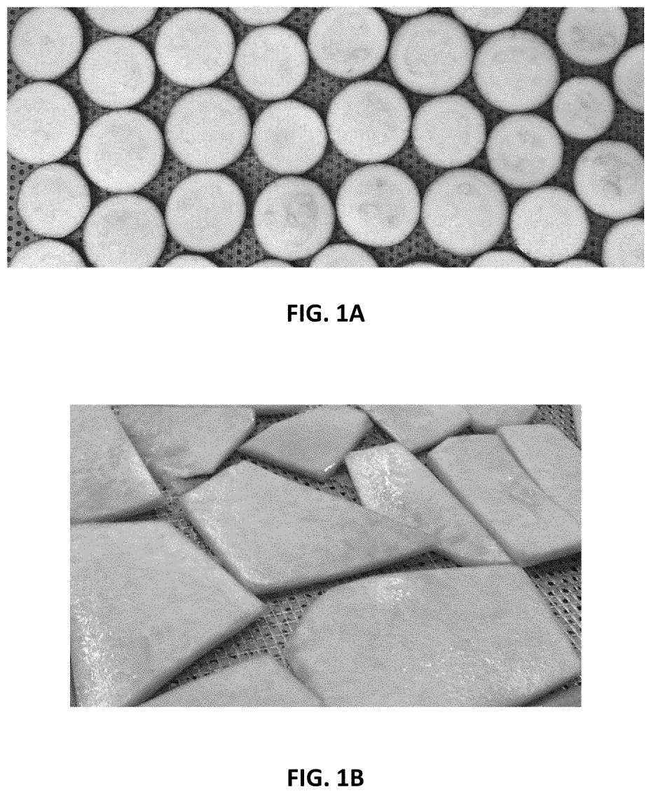

The fruits/vegetables may then undergo iii) cutting, slicing, grinding, mincing or otherwise fragmenting the fruits/vegetables into pieces/slices/puree. Preferably, the thickness of the slices/pieces obtained is about 3-5 mm and no more than 8 mm. According to some embodiments, the cutting may be done using an industrial fruit/vegetable slicer as known in the industry. Non-limiting examples of sliced vegetables (here zucchini and pumpkin) are shown in FIG. 1A and FIG. 1B.

Following the cutting, the fruits/vegetables may iv) be immersed in a solution (e.g. water with a natural antioxidant such as but not limited to lemon extract and/or acerola) configured to preserve the natural color of the fruits/vegetables.

Next v) the fruits/vegetables are dried. According to some embodiments, the drying may include freeze drying. According to some embodiments, the fruits/vegetables may be air dried, preferable at a temperature of about 40° C.-100° C., about 40° C.-80° C. or about 50° C.-75° C. for a suitable amount of time. Each possibility is a separate embodiment. According to some embodiments the air-drying may include temperature fluctuation or applying of a temperature gradient.

According to some embodiments, the fruits/vegetables may be semi-dried, such that a water content of 10%-35% is maintained. Alternatively, the fruits/vegetables may be dried to remove essentially all water (water content below 5%, below 2%, or below 1%) whereafter the fruits/vegetables are rehydrated to a water content of 10%-35%, so as to enable molding thereof.

Step b) is now explained in more detail. It is however clear that at least some of the steps described may be omitted, adjusted and/or their order changed.

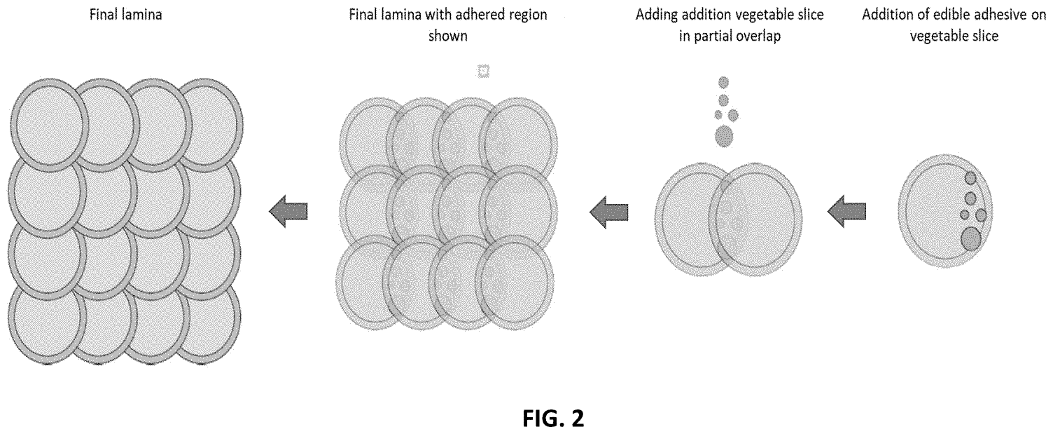

According to some embodiments, preparation of the laminates may include a i) flatting of the fruits/vegetables and ii) arrangement of the fruit/vegetables in such a manner that a continuous sheet is obtained. According to some embodiments, the arranging may include arranging fruit/vegetable slices in such manner that each slice at least partially overlaps with a neighboring slice, as illustratively depicted in FIG. 2. According to some embodiments, the arranging may include dispersing chopped and/or minced fruits/vegetables into an essentially even sheet. According to some embodiments, arranging the fruits/vegetables further include adding the edible adhesive so as to ensure the integrity of the lamina.

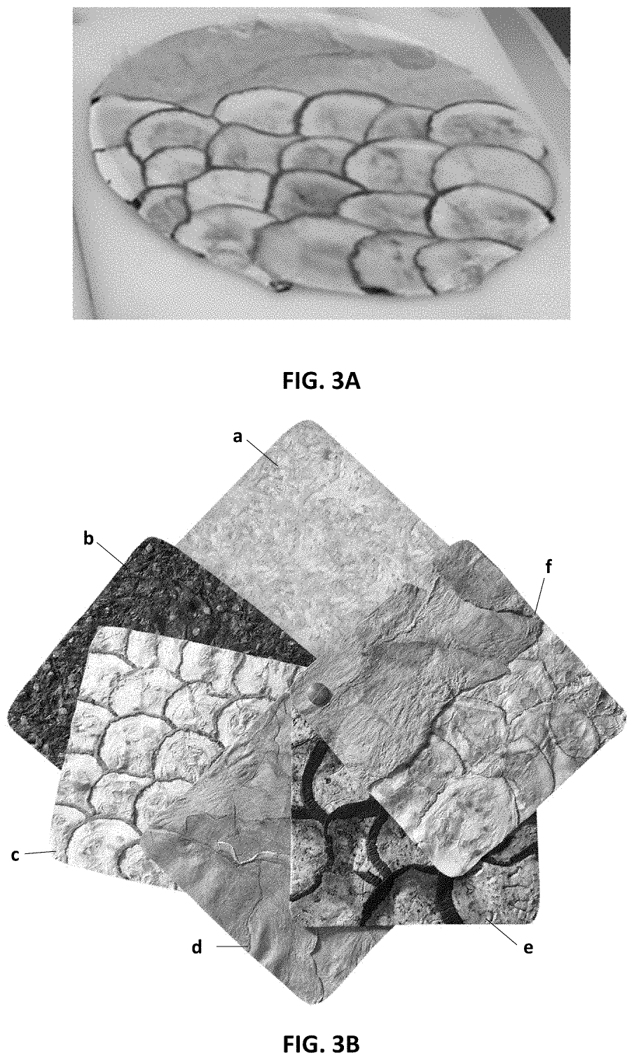

FIG. 3A shows an illustrative image of a lamina, here in circular shape made of different types of vegetables (here zucchini and pumpkin). FIG. 3B shows additional illustrative image of a laminas (a-f) made of different types of vegetables.

It is understood that the shape of the lamina may be rectangular, circular oval or any other desired shape, preferable a shape suitable for molding of the laminate into a desired configuration.

One suitable application of the herein described lamina, is for encapsulation of food-products which collectively form a ready-to-cook meal as essentially described herein.

The process for manufacturing, the ready-to-cook meal is now described in further detail. It is however clear that at least some of the steps described in this regard may be omitted, adjusted and/or their order changed.

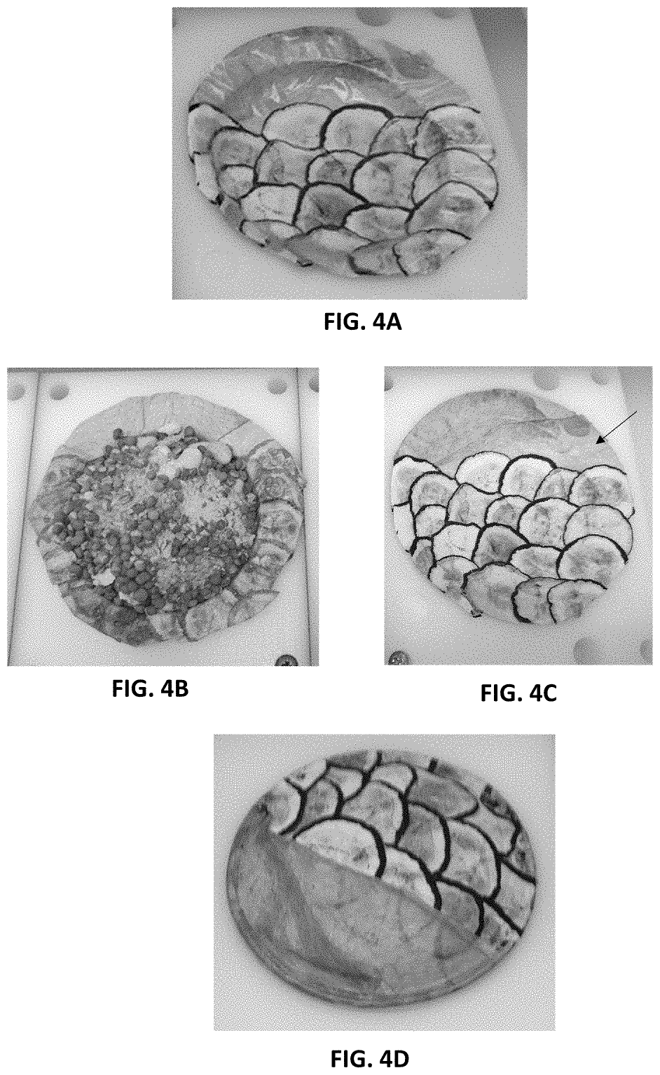

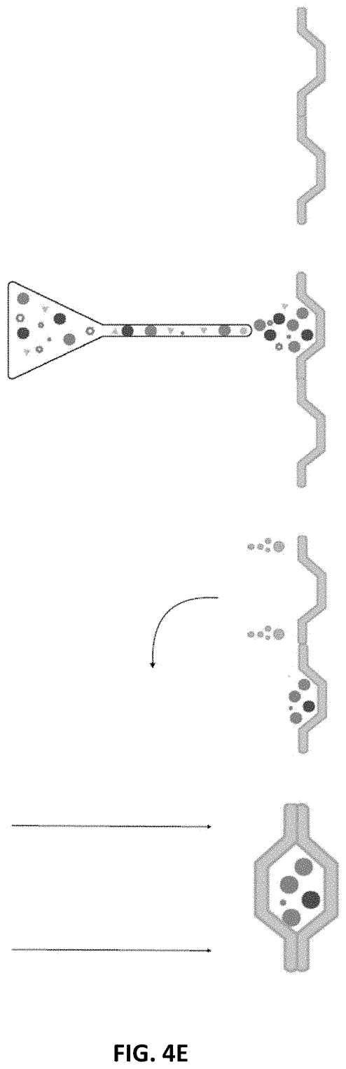

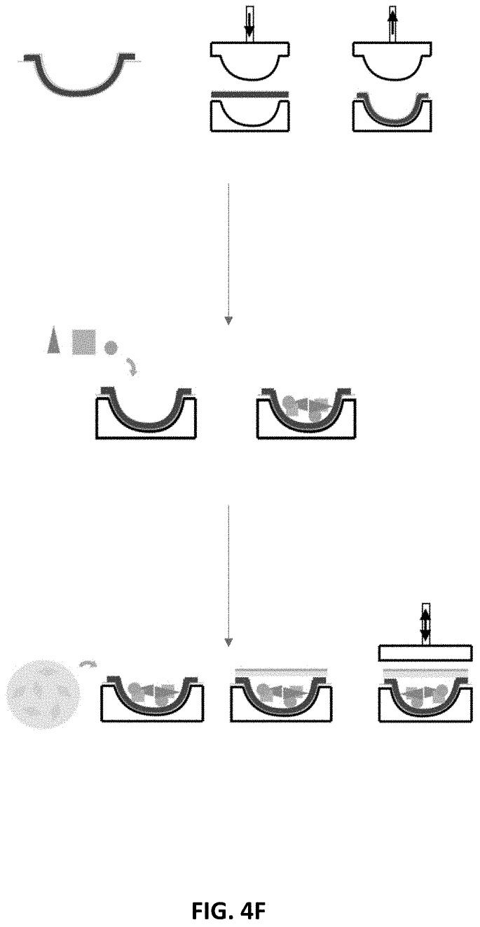

According to some embodiments, the first step for preparing the ready-to-cook meal is to mold the herein disclosed fruit/vegetable lamina into a desired shape enabling encapsulation of the food product. A non-limiting example of such shape is the bowl shape pictured in FIG. 4A.

Next, the food product may be placed in the bowl, as shown in FIG. 4B. The herein disclosed adhesive, may then be added to the rim of another bowl-shaped lamina (FIG. 4C) and the two bowls attached to form a final capsule-like ready-to-cook-meal, as shown in FIG. 4D.

The herein-above detailed process of encapsulation with 2 molded lamina is illustrated in FIG. 4E.

Yet, according to another embodiment, the process of encapsulation may also be performed with only one molded lamina. This is illustrated in FIG. 4F wherein the first lamina, used to create the round bottom of the capsule (i.e., bowl shaped) is placed above a bowl shaped mold and then pressed down to receive its bowl shaped form, the dry essentially non-cooked food product is placed in bowl and the herein disclosed adhesive may then be added to the rim, while a second sheet is placed flat over the newly formed round bottom first lamina to receive the closed capsule-like ready-to-cook-meal. In accordance, according to some embodiments, at least the first lamina is molded into a bowl shaped.

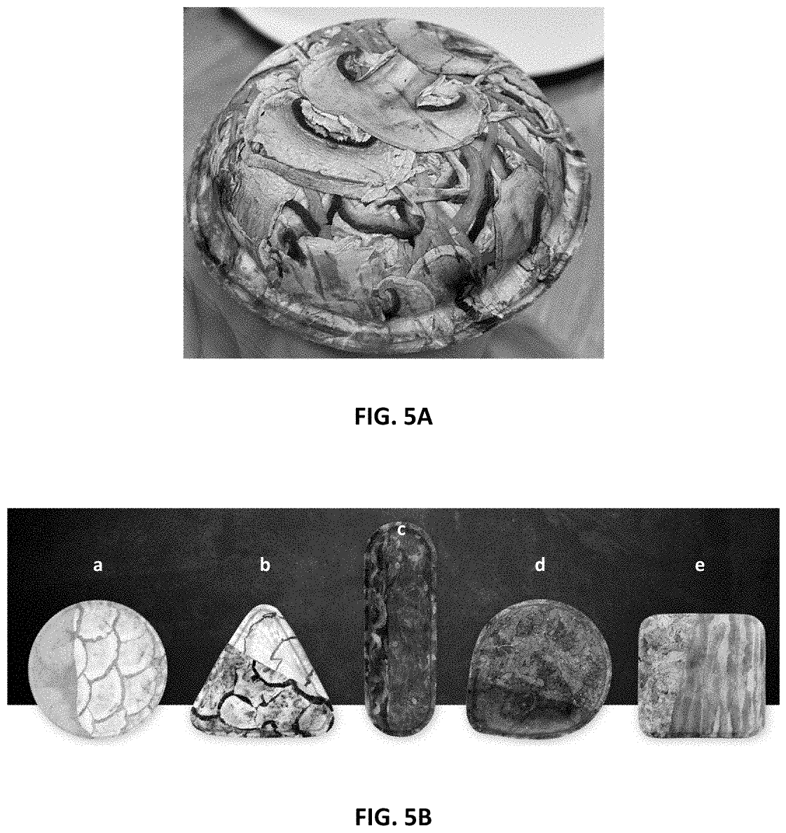

It is understood that by varying the type of fruit/vegetable used and/or their cutting, different ready-to-cook meals may be obtained. As a non-limiting example, FIG. 5A shows a ready to cook meal in which the lamina is formed from an assortment of sliced and chopped vegetables.

Other non-limiting examples are shown in FIG. 5B shows ready to cook meals having various shapes and formed from various combinations of vegetables (a-e).

According to some embodiments, there is provided a food grade adhesive composition comprising a plant resin and one or more additional ingredients selected from a natural starch, a fiber, a sugar, a protein or any combination thereof.

According to some embodiments, the plant resin is selected from amber, balm of Gilead, balsam, Canada balsam, Boswellia, copal from trees of Protium copal and Hymenaea courbaril, dammar gum from trees of the family Dipterocarpaceae, dragon's blood from the dragon trees (Dracaena species), elemi, frankincense from Boswellia sacra, galbanum from Ferula gummosa, gum guaiacum from the Lignum vitae trees of the genus Guaiacum, kauri gum from trees of Agathis australis, hashish (Cannabis resin) from Cannabis indica, labdanum from mediterranean species of cistus, mastic (plant resin) from the mastic tree Pistacia lentiscus, myrrh from shrubs of Commiphora, sandarac resin from Tetraclinis articulata, the national tree of Malta, styrax (a Benzoin resin from various Styrax species), spinifex resin from Australian grasses or any combination thereof.

Preferably, the plant resin may be a natural mucilage and/or a plant gum.

According to some embodiments, the mucilage may be an isolated mucilage. According to some embodiments, the mucilage may be an ingredient in an extract/paste of the plant.

As a non-limiting example, the mucilage may be a mucilage derived from okra, chia, sabras, flaxseed, fenugreek, zucchini, Aloe vera, cactus, kelp, liquorice root, marshmallow, psyllium seed husks or any combination thereof. Each possibility is a separate embodiment. Preferably, the mucilage may be a mucilage derived from okra, chia, sabras, flaxseed, fenugreek, zucchini, or any combination thereof. Each possibility is a separate embodiment. According to some specific embodiments, the plant resin comprises mucilage derived from a plant from the plant family Cucurbitaceae, which includes zucchini/marrows, pumpkins and cucumbers. According to some specific embodiments, the plant resin comprises mucilage derived from a plant from the Cucurbita pepo species. According to some specific embodiments, the plant resin comprises mucilage derived from zucchini (also referred to as courgette and marrow).

According to some embodiments, the adhesive may have a breaking time of about 5 minutes or above, of about 7 minutes or above, of about 10 minutes or above or of about 12 minutes or above, as measured according to the protocol provided in Example 2. Each possibility is separate embodiment.

According to some embodiments, the additional ingredient may be configured to adjust (e.g. prolong or shorten) the time-to-disintegration of the lamina.

According to some embodiments, the additional ingredient may be configured to serve as a stabilizer and/or natural preservative.

As a non-limiting example, the fiber may be a fructooligosaccharide (FOS) fiber. According to some embodiments, the FOS fiber may be extracted from blue agave plant as well as from fruits and vegetables such as bananas, onions, chicory root, garlic, asparagus, jicama, and leeks, grains and cereals, such as wheat and barley, Jerusalem artichoke, yacón or any combination thereof. Each possibility is a separate embodiment.

According to some embodiments, the adhesive may include approximately 1%-60% w/w, approximately 5%-50% w/w, approximately 10%-50%, approximately 10%-40% or any other range within 1%-60% of the additional ingredient (e.g. FOS).

According to some embodiments, the starch may be rice starch, potato starch, arrowroot starch, tapioca starch, cornstarch or any combination thereof. Each possibility is a separate embodiment.

Additionally or alternatively, the adhesive may further include a exudate gum. Non-limiting examples of exudate gums include acacia gum (also referred to as gum Arabic), karaya gum, ghatti gum, tragacanth gum and combinations thereof. Each possibility is a separate embodiment.

According to some embodiments, the adhesive may have a viscosity of at least 10 cP, at a shear force of 0.1 s⁻¹. According to some embodiments, the adhesive may have a viscosity in a range of about 5-100 cP, at a shear force of about 0.1 s⁻¹. According to some embodiments, the adhesive may have a viscosity of at least about 0.5-5 cP, at a shear force of about 100 s⁻¹.

According to some embodiments, the adhesive may be devoid of artificial ingredients and synthetic chemicals.

According to some embodiments, there is provided a use of adhesive composition for adhering food components (edible material) or for adhering non-edible materials used in the food industry (e.g. packaging), the adhesive comprising a mucilage derived from a plant from the plant family Cucurbitaceae. According to some specific embodiments, the plant resin comprises mucilage derived from a plant from the Cucurbita pepo species. According to some specific embodiments, the plant resin comprises mucilage derived from zucchini.

According to some embodiments, the mucilage may mucilage isolated from the zucchini. According to some embodiments, the mucilage may be an ingredient in a zucchini extract/paste.

According to some embodiments, the adhesive may have a breaking time of about 5 minutes or above, of about 7 minutes or above, of about 10 minutes or above or of about 12 minutes or above, as measured according to the protocol provided in Example 2. Each possibility is separate embodiment.

According to some embodiments, the adhesive may further include one or more additional ingredients selected from a natural starch, a fiber, a sugar, a protein or any combination thereof.

According to some embodiments, the additional ingredient may be configured to adjust the time-to-disintegration of the lamina.

According to some embodiments, the additional ingredient may be configured to serve as a stabilizer and/or natural preservative.

As a non-limiting example, the fiber may be a fructooligosaccharide (FOS) fiber. According to some embodiments, the FOS fiber may be extracted from blue agave plant as well as from fruits and vegetables such as bananas, onions, chicory root, garlic, asparagus, jicama, and leeks, grains and cereals, such as wheat and barley, Jerusalem artichoke, yacón or any combination thereof. Each possibility is a separate embodiment.

According to some embodiments, the adhesive may include approximately 1%-60% w/w, approximately 5%-50% w/w, approximately 10%-50%, approximately 10%-40% or any other range within 1%-60% of the additional ingredient (e.g. FOS).

According to some embodiments, the starch may be rice starch, potato starch, arrowroot starch, tapioca starch, cornstarch or any combination thereof. Each possibility is a separate embodiment.

Additionally or alternatively, the adhesive may further include a exudate gum. Non-limiting examples of exudate gums include acacia gum (also referred to as gum Arabic), karaya gum, ghatti gum, tragacanth gum and combinations thereof. Each possibility is a separate embodiment.

According to some embodiments, the adhesive may have a viscosity of at least about 10 cP, at a shear force of about 0.1 s⁻¹. According to some embodiments, the adhesive may have a viscosity in a range of approximately 5-100 cP, at a shear force of about 0.1 s⁻¹. According to some embodiments, the adhesive may have a viscosity of at least about 0.5-5 cP, at a shear force of about 100 s⁻¹.

According to some embodiments, the adhesive may be devoid of artificial ingredients and synthetic chemicals.

According to some embodiments, the maximal pressure required to crack a molded lamina in its 3D capsule like shape is at least about 0.05 Mpa, at least about 0.1 Mpa, at least about 0.15 Mpa at least about 0.2 Mpa, at least about 0.3 Mpa, at least about 0.4 Mpa, at least about 0.5 Mpa. at least about 0.6 Mpa. Each possibility is a separate embodiment.

According to some embodiments, the maximal pressure required to crack a molded lamina in its 3D capsule like shape ranges between about 0.05 Mpa to about 0.50 Mpa, between about 0.05 Mpa to about 0.2 Mpa, between about 0.1 Mpa to about 0.4 Mpa, between about 0.1 Mpa to about 0.3 Mpa, between about 0.1 Mpa to about 0.2 Mpa. Each possibility is a separate embodiment.

According to some embodiments, sweet snack bars or sweet breakfast meals are prepared from a lamina based on fruits.

According to some embodiments, a sweet breakfast meal or a sweet snack bar lamina may comprise at least 60% fruits, at least 70% fruits, preferably at least 80% fruits, at least 90% fruits, at least 95% fruits or at least 99% fruits. Each possibility is a separate embodiment.

According to some embodiments, fruit lamina is prepared from slices of fruits with a thickness of 1-2 mm. Additionally or alternatively, the fruit lamina is prepared from a fruit leather. According to some embodiments, the thickness of the lamina may depend on the type of fruit or fruit leather. A non-limiting example of a fruit leather is banana leather made of mash and pieces.

According to some embodiments, fruit lamina and/or the fruit leather is devoid of oil or added fat.

According to some embodiments, fruit lamina is prepared from different types of fruits. Non-limiting examples of fruits used to prepare lamina include: tree fruits (e.g. apples, peaches, plumbs), tropical/subtropical fruits (for example: banana, pineapple, papaya, mango, guava) and ground fruits (for example: watermelon, melon).

According to some embodiments, the fruits are dried before lamina is created. According to some embodiments, the fruits may be semi-dried, such that a water content of 5%-20% is maintained. Alternatively, the fruits may be dried to remove essentially all water (water content below 5%, below 2% or below 1%) whereafter the fruits/vegetables are rehydrated to a water content of 5%-20%, so as to enable molding thereof.

According to some embodiments, the laminae is then molded, filled, and sealed.

Non-limiting examples of products used for filling fruit lamina include: nuts, seeds, serials like oat or puffed rice, roasted or natural, dehydrated fruits, honey, and maple. Each possibility is a separate embodiment.

According to some embodiments, the fruit product may include salt and/or spices. According to some embodiments, the fruit product may be devoid of added sugar.

According to some embodiments, the fruit product may be a snack bar. According to some embodiments, the fruit product is ready to eat and no further cooking/preparation is required.

According to some embodiments, the fruit product is a breakfast meal. According to some embodiments, prior to eating of the ready-to-cook breakfast meal the lamina can be rehydrated by adding water, milk, milk substitutes, juice, or any other liquid. Each possibility is a separate embodiment.

According to some embodiments, the lamina of the breakfast meal may further include vegetables.

According to some embodiments, the breakfast lamina may comprise less than 40% vegetables, less than 30% vegetables, less than 20% vegetables, less than 10% vegetables, less than 5% vegetables. Each possibility is a separate embodiment.

According to some embodiments, the breakfast lamina may comprise between about 5% to 30% vegetables and between about 70% to 95% fruits, between about 10% to 25% vegetables and between about 75% to 90% fruits, between about 15% to 20% vegetables and between about 80% to 85% fruits

According to some embodiments, the adhesive composition may include a second mucilage derived from okra, chia, sabras, flaxseed, fenugreek, zucchini, Aloe vera, cactus, kelp, liquorice root, marshmallow, psyllium seed husks or any combination thereof. Each possibility is a separate embodiment. Preferably, the mucilage may be a mucilage derived from okra, chia, sabras, flaxseed, fenugreek, zucchini, or any combination thereof. Each possibility is a separate embodiment.

As used herein, the term “essentially” may refer to a deviation from a stated amount by ±1%, ±2% or ±5%. Each possibility is a separate embodiment. According to some embodiments, the term “essentially devoid of” may refer to a the stated material is either entirely absent or present in a residual amount, such as less than 1%, less than 0.5% or less than 0.1%. Each possibility is a separate embodiment.

As used herein, the term “comprising” is synonymous with the terms “including,” “containing,” or “characterized by,” and is inclusive or open-ended i.e. does not exclude additional, unrecited elements. According to some embodiments, the term comprising may be replaced with the term “consisting of” which excludes any element, step, or ingredient not specified in the claim or with the term “consisting essentially of” which limits the scope of a claim to the specified materials or steps “and those that do not materially affect the basic and novel characteristics” of the claimed invention.

As used herein, the terms “about” and “approximately” may be interchangeably used when referring to a measurable value such as an amount, a temporal duration, and the like, is meant to encompass variations of ±20% or in some instances ±10%, or in some instances ±5%, or in some instances ±1%, from the specified value, as such variations are appropriate to perform the disclosed methods.

The following examples are included to demonstrate examples of certain preferred embodiments of the invention. It should be appreciated by those of skill in the art that the techniques disclosed in the examples that follow represent approaches the inventors have found function well in the practice of the invention, and thus can be considered to constitute examples of preferred modes for its practice. However, those of skill in the art should, in light of the present disclosure, appreciate that many changes can be made in the specific embodiments that are disclosed and still obtain a like or similar result without departing from the spirit and scope of the invention.

### EXAMPLES

### Example 1—Controlling Lamina Breaking Time

An in important factor of the herein disclosed lamina is the ability to control its time to breakage. This is important, for example, in order to provide the desired cooking time of the dry food product contained with the capsule of the herein disclosed ready-to-cook meal.

Different resins were thus tested for their impact on the braking time of the herein disclosed laminas using the following protocol:

A lamina, prepared as described herein, here a lamina made of four slices of zucchini glued together using a predetermined amount of an adhesive made of mucilage derived from okra, chia, sabres, flaxseed, fenugreek or zucchini. The lamina is the placed in a pot containing 1 L of boiling water (time 0). The time until at least two slices detach from the lamina is recorded.

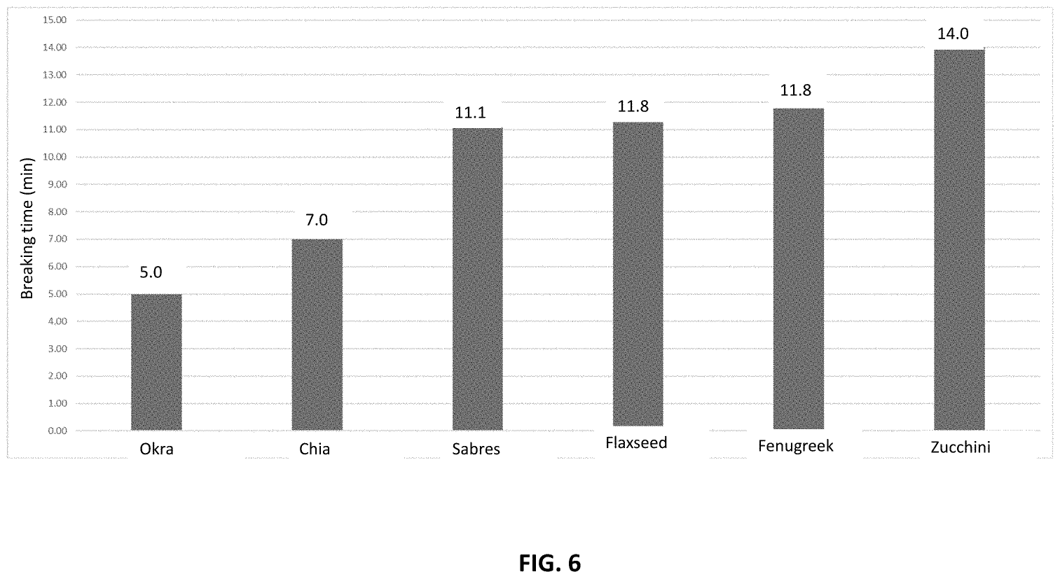

As seen from FIG. 6, which shows a representative histogram of lamina breaking time depending on source of adhesive, using mucilage derived from different sources changes the breaking time and thus advantageously enables controlling the cooking time of the lamina. This may for example be of importance when utilizing the lamina for the herein disclosed ready-to-cook meals. For example, when dry-food products, which require a relatively long cooking time, are encapsulated by the lamina, a shorter breaking time may be desired and adhesives based on okra or chia mucilage may thus be chosen. On the opposite, when dry-food products which require a relatively short cooking time are encapsulated by the lamina, a longer breaking time may be desired, and adhesives based on flaxseed or zucchini may thus be preferred.

### Example 2—Adjusting Lamina Breaking Time

In order to further increase the controllability of the breaking time of the lamina, the impact of adding fiber to the glue was evaluated.

The same protocol as described in example 1 was utilized, with the difference that increasing concentrations of FOS were added to the glue.

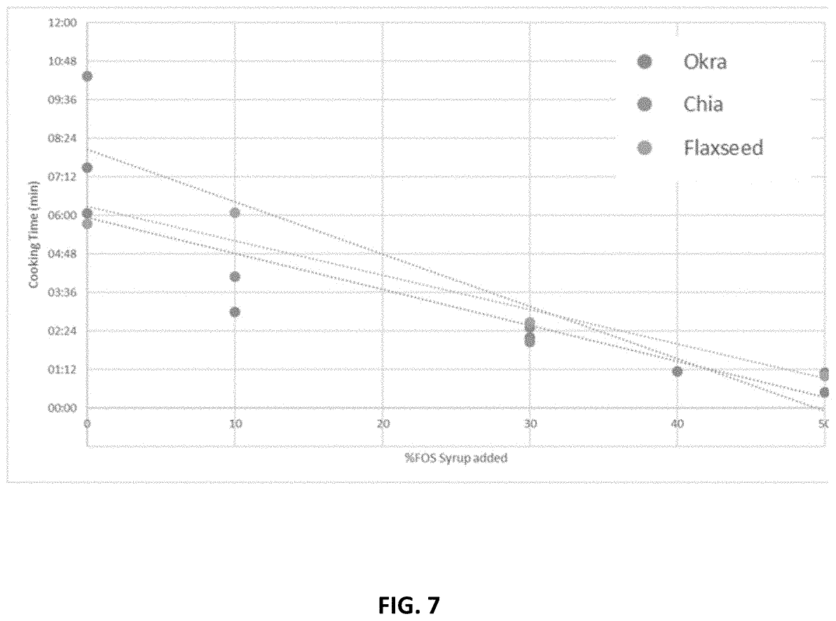

As seen from FIG. 7, which is a representative graph showing the breaking time of a lamina as disclosed herein, depending on the amount of fiber added to the adhesive, adding fiber to the adhesive caused a reduction in the breaking time in a dose-dependent manner, thereby demonstrating that adding different amount of FOS to an adhesive may be used to further control the breaking time of the lamina.

### Example 3—Lamina Chemical and Physical Properties

The lamina's chemical and physical properties were assessed according to specific characteristics including its tendency to absorb water (i.e., moisture), its water activity (aW), its ability to withstand pressure (i.e., strength), and its texture.

10 types of vegetables were sliced into round pieces according to the protocol developed per type of vegetable. Vegetables were then dried in the regular procedure and the veggie slices were assembled together in a specific pattern to create the lamina. Lamina samples were used for moisture and aW evaluation, while the other laminae samples were moved to encapsulation for strength/pressure and texture analyses.

Moisture and Water Activity (aW)—

To characterize the tendency of the lamina and the capsule to absorb water (i.e., moisture) and their water activity (aW), lamina samples and capsule samples were vacuumed packed and sent to an external lab for measurements of moisture balance and aW. The evaluation was performed before (moldable lamina/wet) and after drying the lamina (dried lamina), as well as on the dried capsule. The results of the moisture balance and the aW are summarized in Tables 1-3.

Results of the moisture balance of the lamina are summarized in the herein below Table 1.

The results presented in Table 1 below show that laminae have a water content in a range of 15%-35% in a first moldable configuration (i.e., wet/molded lamina) and a water content of 5%-20% in a second non-moldable final configuration (i.e., dry).

TABLE 1
Moisture balance of wet and dried lamina

| | Moldable laminate | | Dry laminate | |
|---|---|---|---|---|
| | Moisture | Moisture | Moisture | Moisture |
| Veggie | % (ave) | % (std) | % (ave) | % (std) |
| Beet | 24.0 | 0.3 | 7.3 | 0.3 |
| Carrot | 21.3 | 3.6 | 8.4 | 1.1 |
| Eggplant | 18.8 | 0.7 | 6.7 | 0.1 |
| Potato | 28.1 | 6.5 | 6.8 | 0.1 |
| Pumpkin | 30.1 | 2.9 | 14.2 | 1.7 |
| Spinach | 33.7 | 1.4 | 8.3 | 0.5 |
| Tomato | 24.1 | 2.4 | 17.3 | 0.8 |
| Tomato (megi) | 21.7 | 4.2 | 15.3 | 3.1 |
| Zucchini | 18.9 | 5.2 | 12.2 | 1.8 |

The results of the aW of the lamina are summarized in Tables 2 below. The results show that laminae have a water activity in a range of 0.2-0.6.

TABLE 2
Water activity (aW) of wet and dried lamina

| Veggie | aW (ave) | aW (count) | aW (min) | aW (max) |
|---|---|---|---|---|
| beet | 0.5204 | 3 | 0.488 | 0.5385 |
| cabbage | 0.5369 | 1 | 0.5369 | 0.5369 |
| carrot | 0.3770 | 5 | 0.2995 | 0.4409 |
| eggpla | 0.4371 | 2 | 0.3436 | 0.5306 |
| mangold | 0.3878 | 1 | 0.3878 | 0.3878 |
| potato | 0.3734 | 1 | 0.3734 | 0.3734 |
| pumpkin | 0.4752 | 2 | 0.4133 | 0.5371 |
| tomato | 0.4046 | 1 | 0.4046 | 0.4046 |
| zucchi | 0.43805 | 4 | 0.3517 | 0.5208 |

The results of the moisture balance and the aW of the capsule are summarized in Table 3 and show that the capsule's moisture balance is in the range of 7-10 and its aW is in the range of 0.2-0.4.

TABLE 3
Moisture balance and Water activity (aW)
of three different capsule samples:

| Capsule type | Moisture (%) | aW |
|---|---|---|
| Primavera | 7.78 | 0.26 |
| Vietnamese | 8.01 | 0.32 |
| Mediterranean | 9.2 | 0.29 |

Next, strength/pressure and texture analyses were performed on the capsule.

Strength—

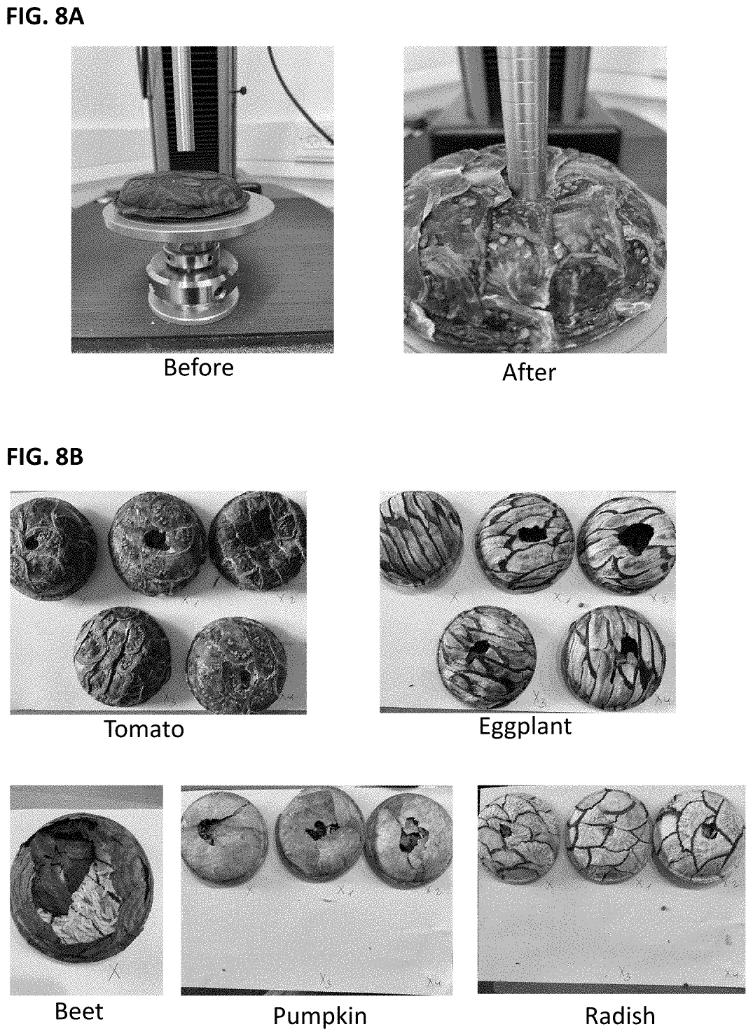

Laminae, each based on a different type of veggie, were assessed for their strength/resistance by testing the ability of the 3D lamina (in a capsule shape) to withstand the pressure applied by a probe. The maximal pressure was measured using a Lioyd device model TA1 and analyzed using NEXYGEN PLUS software. FIG. 8A shows that each capsule was placed in the middle of the samples table while the prob having a diameter of 11.15 mm and a contact area of 97.64 was moved towards the lamina in a speed of 60 mm/min. A preload stress of 3N and a height limit of 15 mm were set. Since the capsule shape is only for holding the lamina still, the pressure applied before the capsule was cracked is the actual maximal pressure required to be applied in order to break a molded laminate. The results are shown in FIG. 8B and summarized in Table 4. The results in the figure show Tomato, Eggplant, Beet, Pumpkin, and Radish 3D capsule shaped laminae cracked open and having a hole, after being tested their maximal strength/maximal ability to withstand the pressure applied by the probe of the Lioyd device. The results show that different Veggies confer different resistance to the 3D shape of capsule. According to the table the average maximal pressure required to crack a hole in a molded lamina ranges between 0.07 Mpa and 0.36 Mpa, where Radish based 3D capsules are the strongest, Eggplant, Pumpkin, Tomato and Zucchini are relatively moderate in their resistance, and Beet being the weakest.

TABLE 4
Maximal strength/resistance of different 3D capsules

| Veggie | Pressure MPa (average) | Pressure MPa (std) |
|---|---|---|
| Beet | 0.074 | NA |
| Eggplant | 0.196 | 0.090 |
| Pumpkin | 0.147 | 0.135 |
| Radish | 0.355 | 0.101 |
| Tomato | 0.110 | 0.118 |
| Zucchini | 0.134 | 0.154 |

### Example 4—Lamina from Fruits

Sweet snack bar or sweet breakfasts are prepared from Lamina based on fruits.

Lamina is prepared based on slices of fruits with a thickness of 1-2 mm depending on the fruit or from fruit's leather, for example banana leather made of mash and pieces, and devoid of oil or added fat.

Fruits from different types, for example: tree fruits, (for example apple, pear), tropical/subtropical fruits (for example: banana, pineapple, passion fruit, coconut) and ground fruits (for example: watermelon, melon) are used. The fruits are dried before lamina is created. The fruit laminae are then molded and filled with, for example, nuts, seeds, serials like oat or puffed rice, roasted or natural, dehydrated fruits, honey, maple, and/or salt. Finally, the molded and filled fruit laminae is sealed.

Sweet snack bar—Sweet snack bar is prepared from fruit lamina as described herein-above. The user is not required for additional step prior to eating of the snack bar fruit product.

Sweet breakfast meal—Sweet breakfast meal is prepared from fruit lamina as described hereinabove. Optionally, vegetables are added to the lamina during its preparation. Prior to eating of the ready-to-cook sweet breakfast the user rehydrates the lamina by adding water, milk, milk substitutes, juice, or any other liquid with or without cooking.

While a number of exemplary aspects and embodiments have been discussed above, those of skill in the art will recognize certain modifications, additions and sub-combinations thereof. It is therefore intended that the following appended claims and claims hereafter introduced be interpreted to include all such modifications, additions and sub-combinations as are within their true spirit and scope.

1.-40. (canceled)

41. A lamina comprising at least 90% w/w dried vegetables, the vegetables sliced, cut or grinded into a desired shape, wherein the lamina has a thickness of 0.5-4 mm, a water content in a range of 5%-35%, and a water activity (aw) of 0.2-0.6, wherein the lamina is configured to withstand disintegration during storage and to allow controlled disintegration into edible vegetables when cooked.

42. The lamina of claim 41, wherein the dried vegetables comprise sliced vegetables and wherein the slices are adhered together, such that two neighboring slices at least partially overlap.

43. The lamina of claim 41, further comprising a natural edible adhesive for adhering the vegetables together, wherein the natural adhesive is a natural constituent of the vegetable or added to the vegetables and wherein the adhesive covers at least a portion of the overlapping surfaces of the vegetable slices.

44. The lamina of claim 41, wherein the adhesive comprises a plant resin, a natural mucilage and/or gum plant gum.

45. The lamina of claim 41, wherein the lamina is devoid of oil or added fat.

46. The lamina of claim 41, wherein the lamina has a strength of 0.05-0.5 Mpa.

47. The lamina of claim 41, wherein the lamina has a water content in a range of 5%-25%.

48. The lamina of claim 41, wherein the lamina has a thickness of 0.5-2 mm.

49. The lamina of claim 41, wherein the lamina has a water content in a range of 10%-35% in a first moldable configuration and a water content of 5%-15% in a second non-moldable final configuration.

50. The lamina of claim 49, wherein the lamina has a water activity (aw) of 0.3-0.5 in its final non-moldable configuration.

51. The lamina of claim 41, comprising at least 95% w/w dried vegetables.

52. The lamina of claim 41, being devoid of artificial ingredients and synthetic chemicals.

53. A ready to cook meal capsule comprising:
an outer encapsulating lamina having a thickness of 0.5-4 mm and a strength of 0.05-0.5 Mpa, the lamina comprising at least 90% w/w dried vegetables sliced, cut or grinded into pieces, a core comprising a dry, essentially non-cooked food product, wherein the lamina of the ready to cook-meal capsule has a water content in a range of 5%-15% and a water activity (aw) of 0.2-0.5, and wherein the lamina is configured to withstand disintegration during storage and even when immersed in room temperature water, and to allow controlled disintegration into edible vegetable slices when cooked, thereby facilitating time-adjusted cooking of the dry, essentially non-cooked food product.

54. The ready to cook meal capsule of claim 53, wherein the outer encapsulating lamina comprises a first lamina and a second lamina, wherein a rim of the first lamina and a rim of the second lamina are adhered to one another, thereby generating a closed capsule encapsulating the dry essentially non-cooked food product.

55. The ready to cook meal capsule of claim 53, wherein at least the first lamina is molded into a bowl shaped.

56. The ready to cook meal capsule of claim 53, wherein the lamina further comprises a natural edible adhesive adhering the vegetable pieces to each other, and wherein an amount and type of the adhesive are determined based on the amount of time required for cooking the dry, essentially non-cooked food product.

57. The ready to cook meal capsule of claim 53, having a water activity (aw) of 0.3-0.4.

58. The ready to cook meal capsule of claim 53, having a shelf life of at least 3 months at room temperature.

59. The ready to cook meal of claim 53, being devoid of artificial ingredients and synthetic chemicals.

60. A breakfast capsule comprising:
an outer encapsulating fruit lamina having a thickness of 0.5-4 mm and a strength of 0.05-0.5 Mpa, the lamina comprising at least 90% w/w dried and sliced, cut, grinded or mashed fruits,
a core comprising nuts, seeds, cereals, dried fruits or any combination thereof;
wherein the lamina of the breakfast capsule has a water content in a range of 5%-15% and a water activity (aw) of 0.2-0.5, and wherein the lamina is configured to withstand disintegration during storage and to allow disintegration thereof when hydrated.
